(19) United States
(12) Patent Application Publication
(10) Pub. No.: US 2024/0283068 A1
(43) Pub. Date: Aug. 22, 2024

(54) BATTERY SYSTEMS WTH MODULAR BATTERY PACKS

(71) Applicant: Enphase Energy, Inc., Petaluma, CA (US)

(72) Inventors: Wei JIANG, Round Rock, TX (US); Vikram Nandakumar IYENGAR, Austin, TX (US)

(21) Appl. No.: 18/416,312

(22) Filed: Jan. 18, 2024

Related U.S. Application Data
(60) Provisional application No. 63/446,461, filed on Feb. 17, 2023.

(51) Int. Cl. H01M 50/204; H01M 10/04; H01M 10/42; H01M 10/48; H01M 50/256; H01M 50/258; H01M 50/262

(52) U.S. Cl. CPC H01M 50/204; H01M 10/0481; H01M 10/425; H01M 10/482; H01M 10/486; H01M 50/256; H01M 50/258; H01M 50/262

(57) ABSTRACT

The present disclosure provides an energy storage system. For example, an energy storage system can comprise a chassis and a battery module. The battery module is configured to removably connect to the chassis and comprises a plurality of battery cells held in place via a pair of end plates configured to compress the plurality of battery cells together when tightened to form the battery module.

### CROSS-REFERENCE TO RELATED APPLICATIONS

The present application claims the benefit of and priority to U.S. Provisional Application Ser. No. 63/446,461, filed on Feb. 17, 2023, the entire contents of which is incorporated herein by reference.

### BACKGROUND

### Field of the Disclosure

Embodiments of the present disclosure relate generally to energy storage systems, and, for example, to energy storage systems comprising battery systems with modular battery packs configured for quick disconnect/connect to a chassis of the energy storage system.

### Description of the Related Art

Energy storage systems configured for use with energy management systems are known. In certain instances, battery cells can be assembled into the energy storage system by using a printed circuit board assembly (PCBA) embedded on a chassis of the energy storage system. The PCBA is configured to connect/disconnect to/from one or more of the battery cells of a battery pack. In some instances, all battery cells in the chassis can be mechanically and electrically integrated to one battery pack. Alternatively, all battery cells in the chassis can be mechanically and electrically integrated to multiple sub/modular battery packs, which are then installed to the chassis. While such approaches need similar procedures and complexity during assembling with automatic/large devices, each approach does present different challenges (e.g., during repair, replacement, and RMA processes). For example, replacing the whole battery pack or individual battery cells can be difficult and/or expensive. For example, considering a weight (more than 170 lbs.), conducting a repair, replacement, and/or RMA of the energy storage system or a single cell (which can require multiple workers) can be difficult and quite expensive. Additionally, shipping an entire energy system from the customer to a repairing facility and back to the customer, not to mention the long lag time to dissemble the entire energy system to replace one or all the battery cells can also be quite expensive.

Accordingly, there is a need for improved energy storage systems comprising battery systems with modular battery packs configured for quick disconnect/connect to a chassis of the energy storage system.

### SUMMARY

Energy storage systems are provided herein. For example, in some embodiments, an energy storage system comprises a chassis and a battery module configured to removably connect to the chassis and comprising a plurality of battery cells held in place via a pair of end plates configured to compress the plurality of battery cells together when tightened to form the battery module.

In accordance with some aspects of the present disclosure, an energy management system comprises a distributed energy resource comprising a renewable energy source, a load center connected to the renewable energy source, and an energy storage system comprising a chassis and a battery module configured to removably connect to the chassis and comprising a plurality of battery cells held in place via a pair of end plates configured to compress the plurality of battery cells together when tightened to form the battery module.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with at least some embodiments of the present disclosure;

FIG. 2 is a diagram of chassis comprising a PCBA with a battery module disconnected and configured for use with the energy management system of FIG. 1, in accordance with at least some embodiments of the present disclosure;

FIG. 3 is a diagram of the chassis of FIG. 2 with the battery module connected, in accordance with at least some embodiments of the present disclosure; and

FIG. 4 is a diagram of chassis comprising a PCBA with a battery module disconnected and configured for use with the energy management system of FIG. 1, in accordance with at least some embodiments of the present disclosure.

### DETAILED DESCRIPTION

Embodiments of the present disclosure relate to improved energy storage systems comprising battery systems with modular battery packs configured for quick disconnect/connect to a chassis of the energy storage system. For example, in at least some embodiments, an energy storage system can comprise a chassis and a battery module configured to removably connect to the chassis. The battery module can comprise a plurality of battery cells held in place via a pair of end plates configured to compress the plurality of battery cells together when tightened to form the battery module. The energy storage systems described herein are relatively inexpensive to manufacture, provide a fast connecting/disconnecting feature (e.g., via the end plate), which eliminates a need of replacing the whole battery pack, ease of replacement of a battery module of the battery pack and the battery cells in the battery module, and can enable quick field replacement of the battery module and/or the battery cells.

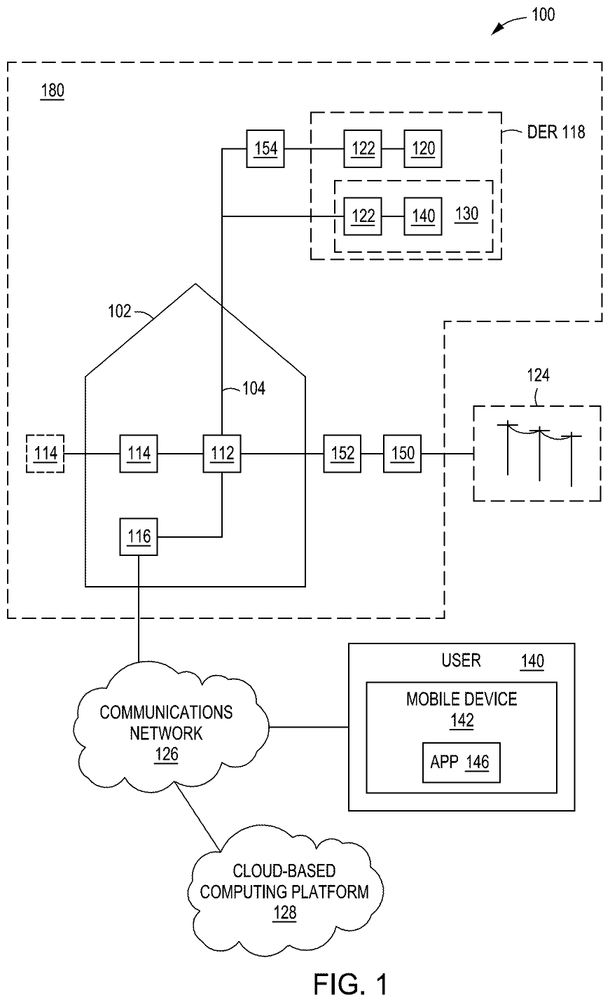

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

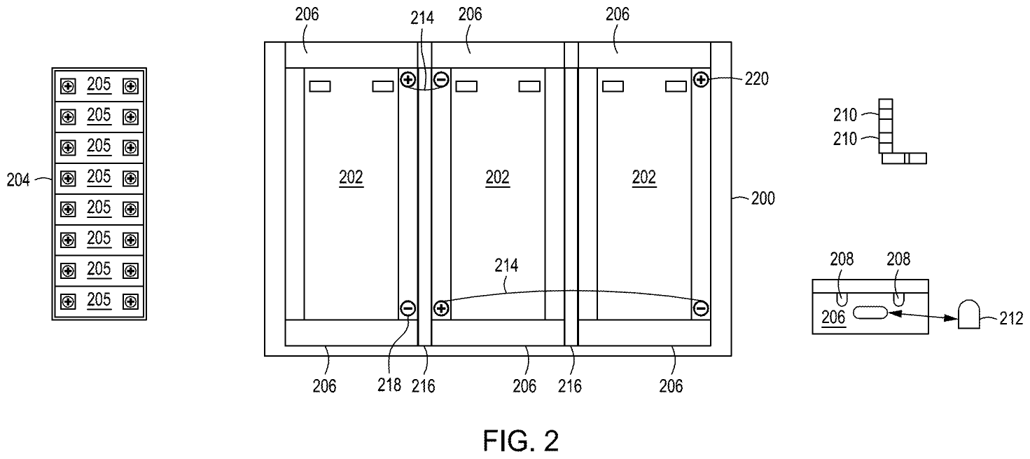

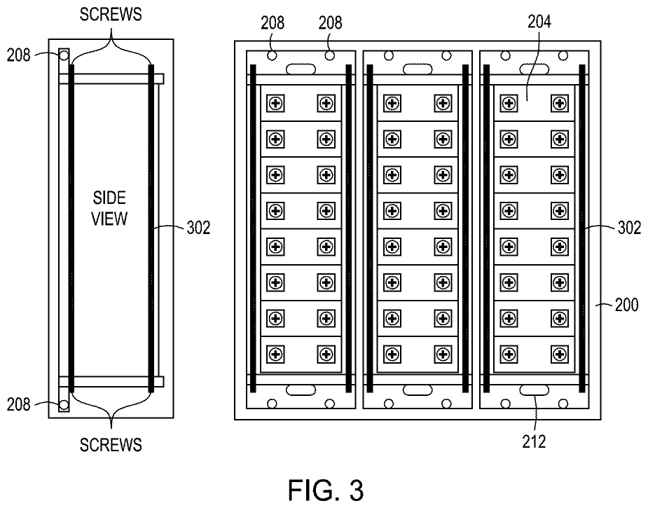

FIG. 2 is a diagram of chassis 200 comprising a PCBA 202 with a battery module disconnected and configured for use with the energy management system of FIG. 1, and FIG. 3 is a diagram of the chassis of FIG. 2 with the battery module connected, in accordance with at least some embodiments of the present disclosure. For example, the chassis 200 can be configured for use with one or more energy storage devices (e.g., the energy storage system 114), such as the storage system disclosed in commonly-owned U.S. patent application Ser. No. 17/145,793, filed Jan. 11, 2021 and entitled “Storage System Configured For Use With An Energy Management System,” the entire contents of which is incorporated herein by reference.

The chassis 200 can be configured to house one or more types of battery pack configurations. For example, the chassis 200 can be configured to house prismatic battery packs, cylindrical battery packs, and/or pouch battery packs. In FIGS. 2 and 3 the chassis 200 is described in terms of use with prismatic battery pack and cylindrical battery packs. For illustrative purposes, the chassis 200 is described configured for use with prismatic battery packs.

For example, unlike conventional chassis that are configured to house a battery pack comprising a plurality of battery cells, the chassis 200 (e.g., AC battery 130) is configured to house one or more battery modules 204 (e.g., one or more sub-battery packs) comprising one or more battery cells 205, which can be connected in series via a bus bar (not shown). For example, each battery module of the one or more battery modules 204 can comprise 1, 2, 3, 4, etc. battery cells. For example, each battery module of the one or more battery modules 204 can comprise up to twelve battery cells, sometimes more. Each battery module of the one or more battery modules 204 can comprise the same number of battery cells or a different number of battery cells. In the illustrated embodiment, each battery module of the one or more battery modules 204 is shown comprising eight battery cells that are held in place via one more connecting/disconnecting apparatus.

For example, each battery module of the one or more battery modules 204 is held in place by a pair of end plates 206 (e.g., a fast connecting/disconnecting feature). For example, each end plate of the pair of end plates 206 has a plurality of apertures 208 that extend along a horizontal plane of each end plate. Similarly, each end plate of the pair of end plates 206 has a plurality of apertures 210 that extend along a vertical plane of each end plate. The plurality of apertures 208 that extend along the horizontal plane of each end plate are configured to receive a corresponding screw that is used to connect each end plate to an inner wall of the chassis 200. The plurality of apertures 210 that extend along the vertical plane of each end plate are configured to receive a corresponding rod (FIG. 3). In at least some embodiments, each end of the rod 302 is threaded and configured to receive a corresponding screw (or nut) that when tighten compresses the pair of end plates 206 toward each other, as will be described in greater detail below. Alternatively, one end of the rod 302 can be threaded and configured to receive the corresponding screw and the other end of the rod 302 can have a flange with a diameter greater than the apertures 210. In use, the rod 302 goes through each end plate of the pair of end plates 206, so that after being fastened with the screws and/or nuts, the rod 302, screws/nuts, and the pair of end plates 206 together apply pressure to the plurality of battery cells 205 and hold the plurality of battery cells 205 together to form the battery module 204.

A lifting structure 212 can be provided on each end plate of the pair of end plates 206 to facilitate taking the battery module 204 in/out of the chassis 200. In at least some embodiments, the lifting structure 212 can be configured for grasping by a hand or fingers of a user.

One or more types of separating material 216 (or compression material) can be provided between adjacent battery modules of the one or more battery modules 204. The separating material 216 is configured to provide a predetermined amount of separation between the adjacent battery modules of the one or more battery modules 204. In at least some embodiments, the separating material 216 can be aerogel, silicon rubber, polymer nanocomposites, etc.

The PCBA 202 is configured to connect/disconnect via voltage (V) and temperature (T) sensing components to the battery module 204. For example, the voltage (V) and temperature (T) sensing components connect to battery tabs of the battery module 204 via screw or welding. The PCBA 202 provides battery status information (V and T) to a battery management unit/system (BMU/S) which could be on a PCU. For example, the V and T sensing components allow the PCBA 202 to sense voltage and temperature and/or current of the battery module 204. Additionally, the PCBA 202 has current paths to optimize cable routing inside the chassis 200. For example, the cables 214 can be used to connect a positive terminal on a battery module to a negative terminal on another battery module (e.g., an adjacent battery module). In at least some embodiments, a negative terminal 218 on a battery module (e.g., a first battery module in the series connection) and a positive terminal 220 on a battery module (e.g., a last battery module in the series connection) can connect to the BMU/S (or PCU).

In operation, a process of replacing the battery module 204 can comprise unplugging a DC+− terminal to the BMU/S. For example, the negative terminal 218 and the positive terminal 220 on the PCBA 202 can be unplugged from the BMU/S (or PCU).

Next, the process can comprise unplugging the cables connecting adjacent battery modules. For example, if a first battery module (e.g., first battery module from a left in FIG. 2) needs to be replaced, the cable 214 connecting the first battery module to a second battery module (e.g., second battery module from a left in FIG. 2) can be unplugged. Similarly, if the second battery module needs to be replaced, the cable 214 connecting the first battery module to the second battery module needs to be unplugged, and the cable 214 connecting the second battery module to a third battery module (e.g., third battery module from a left in FIG. 2) can be unplugged. Likewise, if the third battery module needs to be replaced, the cable 214 connecting the second battery module to the third battery module can be unplugged. In either of the three examples, if only one of the three battery modules needs to be replaced, the remaining two battery modules can be temporarily connected to each other.

Next, the process can comprise unplugging the V and T connectors. For example, the V and T connectors can be unplugged to disconnect the PCBA 202 from the battery module 204.

Next, the screws connecting the pair of end plates 206 to the chassis 200, which go through the plurality of aperture 208, can be loosened. For example, the screws that are used on the horizontal plane can be unscrewed so that the battery module 204 can be removed from the chassis 200.

Once the pair of end plates 206 are sufficiently loosened from the chassis 200, the battery module 204 can be removed (e.g., via the lifting structure 212 on the pair of end plates 206) from the chassis 200, a new battery module can be positioned in the chassis 200, and the screws that are used on the horizontal plane of the new pair of end plates of the new battery module can be screwed to the chassis to reconnect the pair of end plates 206 back to the chassis 200.

The process for changing a battery cell of the battery module is substantially similar to that of changing the battery module. For example, after a battery module is removed from the chassis as described above, the screws that are used on the vertical plane can be unscrewed (e.g., fully/partially) so that the rods can be removed from/loosened at the pair of end plates 206, so that one or more of the battery cells 205 can be removed from the battery module 204. Once the one or more battery cells are removed, one or more new battery cells can be positioned in the battery module 204, the rod 302 can be replaced if removed, the screws that are used on the vertical plane can be tightened, and the plurality of battery cells 205 can be compressed to form the battery module 204, which can be reattached to the chassis 200, as described above.

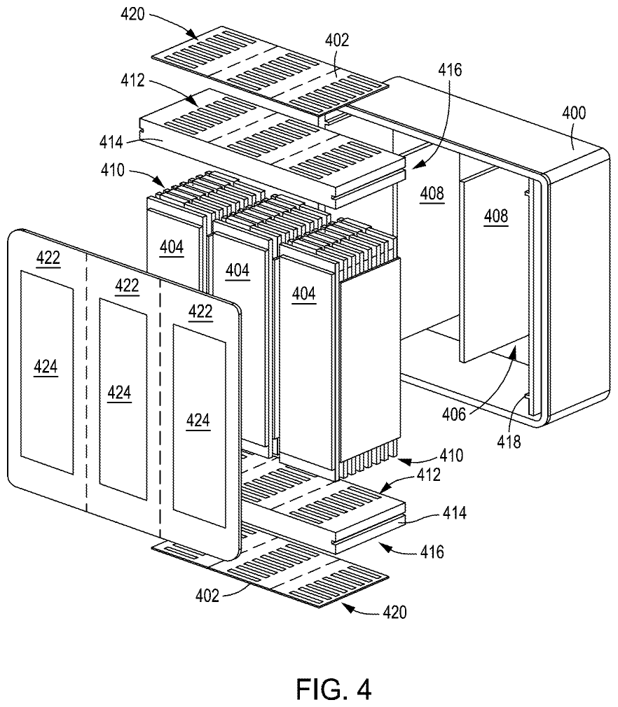

FIG. 4 is a diagram of a chassis 400 comprising a PCBA 402 with a battery module 404 disconnected and configured for use with the energy management system of FIG. 1, in accordance with at least some embodiments of the present disclosure. As noted above, the chassis described herein can be configured to house prismatic battery packs, cylindrical battery packs, and/or pouch battery packs. In FIG. 4, the chassis 400 is described in terms of use with pouch battery packs.

For example, the chassis 400 comprises one or more chambers that are configured to house one or more of the battery modules. For example, the chassis 400 can comprise three chambers 406 that are configured to house three battery modules. Each battery module 404 can comprise a plurality of pouch cells having top and bottom tabs 410. The top and bottom tabs 410 are configured to be received through corresponding slots 412 disposed on top and bottom frames 414, which can be made from plastic, metal, etc. In at least some embodiments, the top and bottom frames 414 are made of plastic. Alternatively, corresponding independent (three separate) top and bottom frames can comprise the corresponding slots 412, e.g., instead of a single top and bottom frame, three separate top and bottom frames can be used, shown by dashed lines.

The top and bottom frames 414 comprise a slot 416 that is configured to be slid into a rail 418 of a sidewall of the chassis 400. In the embodiments where three separate top and bottom frames are used, the slot and rail configuration can also be used to connect one or more of the top and bottom frames to each other. For example, adjacent sides of the three top frames can have a slot and rail configuration, and adjacent sides of the three bottom frames can have a slot and rail configuration. Additionally, the PCBA 402 comprises a plurality of slots 420 that are configured to receive the top and bottom tabs 410 of the plurality of pouch cells of the battery module 404. In at least some embodiments, three separate PCBAs can be used (shown by dashed lines). The top and bottom tabs 410 are electrically connected to the PCBA 402 for communication with the BMU/S (or PCU).

One or more lids are configured to close the chassis 400 and can connect to the chassis 400 via one or more connection apparatus, e.g., screws, tabs, nuts, bolts, etc. In the illustrated embodiment, a lid 422 is connected to the chassis 400 and configured to enclose a the three battery modules within the chassis 400. Alternatively, three separate lids (shown by dashed lines) can be connected to the chassis 400 and configured to enclose the three battery modules within the chassis 400. Compression panels 424 are configured to compress corresponding battery cells within the chassis 400. The chassis 400 comprises two panels 408 that are configured to connect (e.g., screws, nuts, bolts, etc.) to the lid 422 (or the three separate lids) and to provide a barrier between the battery modules.

In use, to assemble and install the battery modules, the top and bottom tabs 410 can be inserted through the corresponding slots 412 disposed on the top and bottom frames 414 and through the corresponding slots 412 on the PCBA 402. Next, the top and bottom tabs 410 can be electrically connected to the PCBA 402 for communication with the BMU/S (or PCU). Next, the slots 416 on the top and bottom frames 414 can be slid into engagement with the rails 418 on the chassis 400. Next, the compression panels 424 can be placed on the openings of the lid(s) and the lid(s) can be attached to the chassis 400. A reverse sequence of the installation steps can be used to replace one or more of the battery modules and/or the battery cells.

While the foregoing is directed to embodiments of the present disclosure, other and further embodiments of the disclosure may be devised without departing from the basic scope thereof, and the scope thereof is determined by the claims that follow.

What is claimed is:

1. An energy storage system, comprising:
a chassis; and
a battery module configured to removably connect to the chassis and comprising a plurality of battery cells held in place via a pair of end plates configured to compress the plurality of battery cells together when tightened to form the battery module.

2. The energy storage system of claim 1, wherein each end plate of the pair of end plates comprises a plurality of apertures.

3. The energy storage system of claim 2, wherein the plurality of apertures comprises a plurality of apertures that extend along a horizontal plane of each end plate and a plurality of apertures that extend along a vertical plane of each end plate.

4. The energy storage system of claim 3, wherein the plurality of apertures that extend along the horizontal plane of each end plate are configured to receive a corresponding screw that is used to connect each end plate to an inner wall of the chassis, and wherein the plurality of apertures that extend along the vertical plane of each end plate are configured to receive a corresponding rod.

5. The energy storage system of claim 1, wherein the plurality of battery cells comprises twelve battery cells.

6. The energy storage system of claim 1, wherein the plurality of battery cells comprises eight battery cells.

7. The energy storage system of claim 1, wherein each end plate of the pair of end plates comprises a lifting structure.

8. The energy storage system of claim 1, wherein the battery module is one of a prismatic battery pack, a cylindrical battery pack, or a pouch battery pack.

9. The energy storage system of claim 1, further comprising a printed circuit board assembly connected to the battery module.

10. The energy storage system of claim 9, wherein the printed circuit board assembly comprises voltage (V) and temperature (T) sensing components that connect to battery tabs of the battery module via screw or welding.

11. An energy management system, comprising:
a distributed energy resource comprising a renewable energy source;
a load center connected to the renewable energy source; and
an energy storage system, comprising:
a chassis; and
a battery module configured to removably connect to the chassis and comprising a plurality of battery cells held in place via a pair of end plates configured to compress the plurality of battery cells together when tightened to form the battery module.

12. The energy management system of claim 11, wherein each end plate of the pair of end plates comprises a plurality of apertures.

13. The energy management system of claim 12, wherein the plurality of apertures comprises a plurality of apertures that extend along a horizontal plane of each end plate and a plurality of apertures that extend along a vertical plane of each end plate.

14. The energy management system of claim 13, wherein the plurality of apertures that extend along the horizontal plane of each end plate are configured to receive a corresponding screw that is used to connect each end plate to an inner wall of the chassis, and wherein the plurality of apertures that extend along the vertical plane of each end plate are configured to receive a corresponding rod.

15. The energy management system of claim 11, wherein the plurality of battery cells comprises twelve battery cells.

16. The energy management system of claim 11, wherein the plurality of battery cells comprises eight battery cells.

17. The energy management system of claim 11, wherein each end plate of the pair of end plates comprises a lifting structure.

18. The energy management system of claim 11, wherein the battery module is one of a prismatic battery pack, a cylindrical battery pack, or a pouch battery pack.

19. The energy management system of claim 11, further comprising a printed circuit board assembly connected to the battery module.

20. The energy management system of claim 19, wherein the printed circuit board assembly comprises voltage (V) and temperature (T) sensing components that connect to battery tabs of the battery module via screw or welding.
